(19) United States
(12) Patent Application Publication
(10) Pub. No.: US 2008/0232728 A1
(43) Pub. Date: Sep. 25, 2008

(54) Linear motion guide apparatus

(75) Inventors: Tsung Jen Chen, Taichung (TW); Yu Wen Tsai, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 11/725,669

(22) Filed: Mar. 20, 2007

(51) Int. Cl. F16C 29/04

(52) U.S. Cl. 384/49

(57) ABSTRACT

A linear motion guide device includes a slider and two end caps attached to side portions of the slider, one or more guide beams attached to the slider and engaged between the end caps for retaining a ball bearing device to the slider, and one or more retaining devices attached to the end caps and engaged with the guide beam for attaching the guide beam to the slider without fasteners or tools, one of the end caps includes a latch device for engaging with one end of the retaining device and for securing the retaining device to the end cap, and the retaining device may include one or more protrusions for engaging with the other end cap.

### BACKGROUND OF THE INVENTION

1. Field of the Invention

The present invention relates to a linear motion guide apparatus, and more particularly to a linear motion guide apparatus including a retaining device solidly attachable to the slider and the end cap for solidly retaining the ball bearing device to the slider and the end cap and for preventing the retaining device and the ball bearing device from being disengaged from the slider and the end cap.

2. Description of the Prior Art

Typical linear motion guide devices comprise a slider or slide block slidably attached onto a guide rail, and normally, a ball bearing device disposed between the slider and the guide rail for facilitating the sliding movement between the slider and the guide rail and for allowing the slider and the guide rail to be smoothly moved relative to each other.

For example, U.S. Pat. No. 6,652,146 to Lee discloses one of the typical linear motion rolling guide devices comprising two offset ball rows disposed between the slider and the guide rail and engaged in an endless ball chain for facilitating the sliding movement between the slider and the guide rail. For solidly attaching and retaining the two offset ball rows to the slider and the guide rail, two guide beams are required to be attached to the slider and the guide rail and engaged with the two offset ball rows and the endless ball chain.

The guide beams include two bent ends required to be engaged with two end caps and/or secured to the end caps for attaching or securing the guide beams and thus the two offset ball rows onto the end caps. However, the bent ends of the guide beams may not be solidly secured or attached to the end caps and may have a good chance to be easily disengaged from the end caps such that the two offset ball rows and the endless ball chain may not be solidly retained in place.

U.S. Pat. No. 7,121,724 to Lee et al. discloses another typical linear motion rolling guide devices also comprising a slider or slide block slidably attached onto a guide rail, and two stops or end caps attached onto the side portions of the slide block, the slide block and the end caps are required to be formed with an endless ball guiding channel therein for receiving the ball bearing device and for allowing the ball bearing device to smoothly move through the linear motion guide apparatus.

Similarly, for solidly attaching and retaining the ball bearing device to the slider and the guide rail, two pressing members are required to be attached to the slider and the guide rail and engaged with the ball bearing device. However, similarly, the pressing members also include only two bent ends engaged with the end caps and may not be solidly secured or attached to the end caps and also may have a good chance to be easily disengaged from the end caps such that the ball bearing device also may not be solidly retained in place.

The present invention has arisen to mitigate and/or obviate the afore-described disadvantages of the conventional linear motion guide apparatuses.

### SUMMARY OF THE INVENTION

The primary objective of the present invention is to provide a linear motion guide apparatus including a retaining device solidly attachable to the slider and the end cap for solidly retaining the ball bearing device to the slider and the end cap and for preventing the retaining device and the ball bearing device from being disengaged from the slider and the end cap.

In accordance with one aspect of the invention, there is provided a linear motion guide apparatus comprising a slider, a first end cap and a second end cap attached to side portions of the slider, at least one guide beam attached to the slider and engaged between the first and the second end caps for engaging with a ball bearing device and for retaining the ball bearing device to the slider, and at least one retaining device attached to the first and the second end caps and engaged with the guide beam for retaining the guide beam to the slider and the first and the second end caps, the guide beam includes at least one projection extended therefrom for engaging with the retaining device and for slidably retaining the retaining device to the guide beam.

The guide beam includes a groove formed therein for slidably receiving the retaining device. The groove of the guide beam is formed by two ribs, and the ribs each include at least one opening formed therein.

The retaining device includes a first end portion engaged with the first end cap and a second end portion engaged with the second end cap. The second end cap includes at least one cavity formed therein, and the retaining device includes at least one protrusion extended from the second end portion thereof for engaging into the cavity of the second end cap and for securing the retaining device to the second end cap.

The first end cap includes a latch device extended therefrom for engaging with the first end portion of the retaining device and for securing the retaining device to the first end cap. The first end cap includes a recess formed therein for receiving the first end portion of the retaining device and for anchoring the first end portion of the retaining device to the first end cap.

The retaining device includes a flap bent from the first end portion thereof for engaging into the recess of the first end cap. The retaining device includes an orifice formed in the flap for engaging with the latch device. The first end cap includes a depression formed therein for receiving the first end portion of the retaining device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a linear motion guide apparatus in accordance with the present invention, in which one half of the linear motion guide apparatus has been cut off for illustrating the interior structure of the linear motion guide apparatus;

FIG. 2 is a partial exploded view of the linear motion guide apparatus;

FIG. 3 is another partial perspective view of the linear motion guide apparatus;

FIG. 4 is a cross sectional view of the linear motion guide apparatus taken along lines 4-4 of FIG. 3;

FIG. 5 is a partial cross sectional view of the linear motion guide apparatus taken along lines 5-5 of FIG. 1; and

FIG. 6 is a partial cross sectional view similar to FIG. 5, illustrating the operation of the linear motion guide apparatus.

### DETAILED DESCRIPTION OF THE PREFERRED EMBODIMENT

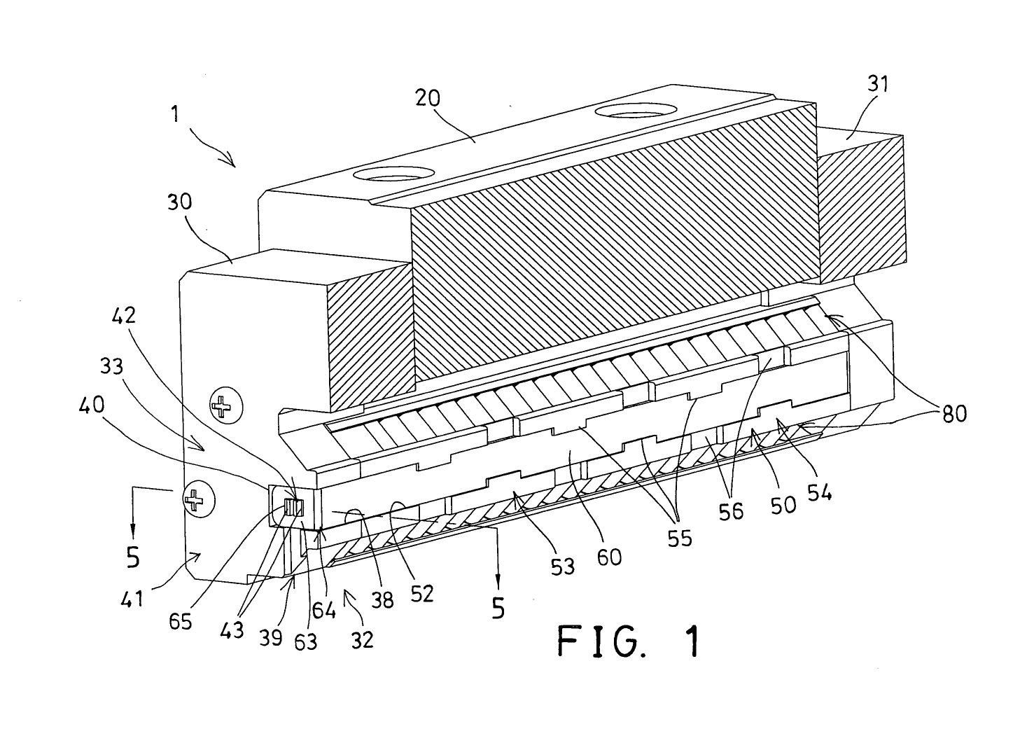

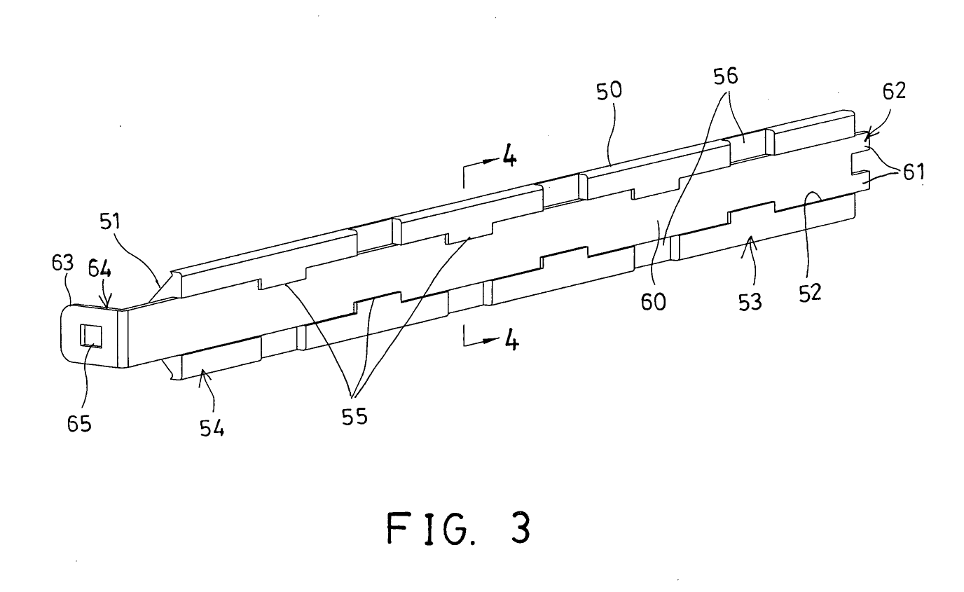

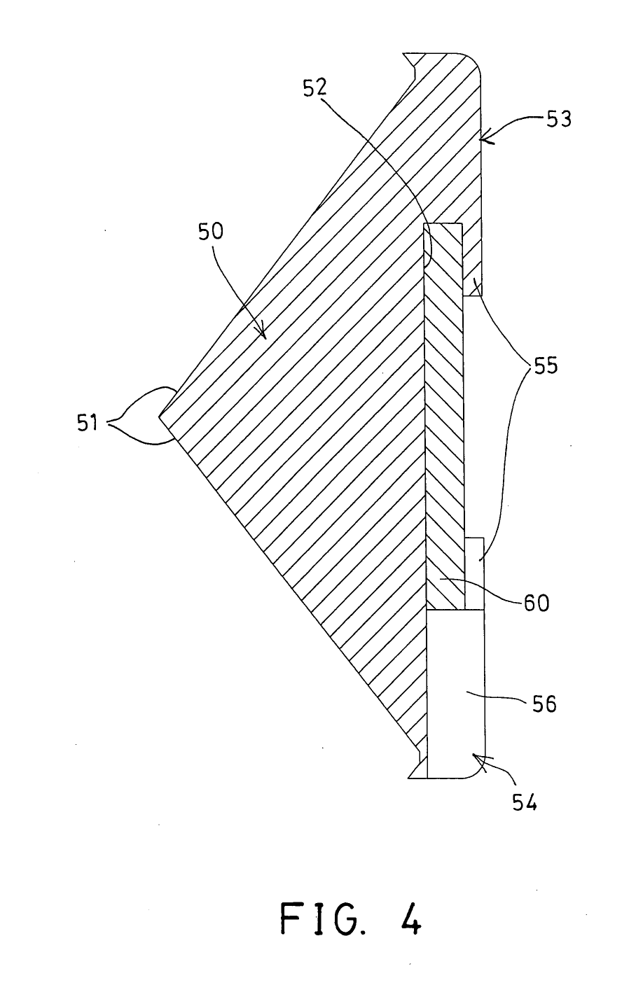

Referring to the drawings, and initially to FIGS. 1-5, a linear motion guide apparatus 1 in accordance with the present invention comprises a slide block or a slider 20 for slidably attaching onto a guide rail (not shown) and arranged to be moved along the guide rail, and normally, two end caps 30, 31 disposed on the two sides or end portions or outer portions of the slider 20 and attached or secured to the slider 20 with such as fasteners or latches (not shown) or the like. Two dust caps or wipers (not shown) may further be provided and disposed on the outer portions of the end caps 30, 31 and to be attached or secured onto the end caps 30, 31 with such as fasteners or latches (not shown) or the like. The configurations of the guide rail and the dust caps or wipers are not related to the present invention and will not be described in further details.

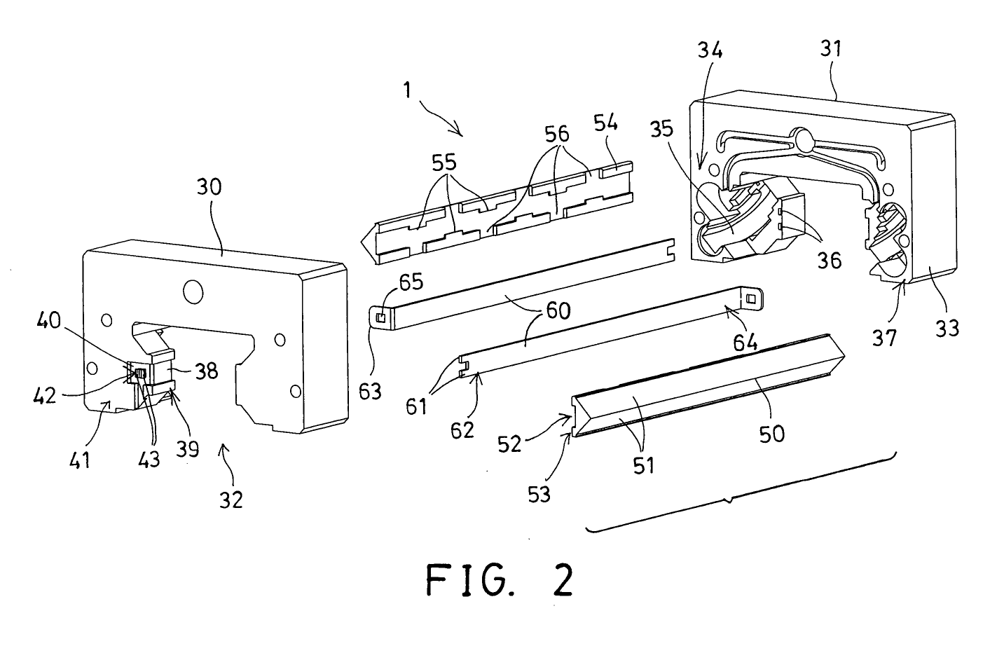

As shown in FIG. 1, a ball bearing device 80 includes a number of balls or rollers or rolling members and is to be disposed between the slider 20 and the guide rail and/or the end caps 30, 31 for facilitating the sliding movement between the slider 20 and the guide rail and for allowing the slider 20 and the guide rail to be smoothly moved relative to each other. As shown in FIGS. 1 and 2, the slider 20 and the end caps 30, 31 each include a concave 32 formed in the lower portion thereof for forming two legs 33, 34 (FIG. 2) and for slidably receiving or engaging onto the guide rail and for allowing the slider 20 and the end caps 30, 31 to be guided to slide along the guide rail. One or more (such as two) guide beams 50 are attached to the slider 20 and engaged between the end caps 30, 31 and to be detachably secured or retained to the slider 20 and the end caps 30, 31 with two retaining devices 60 respectively without additional fasteners or tools.

The guide beams 50 preferably includes a triangular cross section having two tilted or inclined surfaces 51 formed in one side or the inner side thereof and facing toward the slider 20 for engaging with the ball bearing device 80 and for retaining the ball bearing device 80 to the slider 20 and/or the end caps 30, 31 and for guiding the ball bearing device 80 to smoothly move through one or more endless fore-and-aft raceway grooves or ball return pathways or ball guiding channels (not shown) of the linear motion guide apparatus 1. The end caps 30, 31 each include one or more ball deflecting or changing paths or turnarounds 35 formed therein (FIG. 2) for engaging with the ball bearing device 80 and for further guiding the ball bearing device 80 to smoothly move through the ball guiding channels formed or provided in the slider 20 and the end caps 30, 31 of the linear motion guide apparatus 1.

The guide beams 50 each include a longitudinal groove 52 formed in the other or outer side portion 53 thereof and facing toward the guide rail and formed or defined between two ribs 54 for slidably receiving the retaining devices 60 respectively, and one or more ears or projections 55 extended from the ribs 54 into the longitudinal groove 52 of the guide beams 50 for engaging with the retaining devices 60 and for slidably attaching or retaining the retaining devices 60 to the guide beams 50. It is preferable that the guide beams 50 each further include one or more notches or openings 56 formed in each of the ribs 54 for increasing the flexibility of the guide beams 50 and/or of the projections 55 of the guide beams 50.

The end caps 30, 31 each include one or more cavities 36 (FIG. 2) formed in one of the legs 34 and formed in one side or inner side 37 thereof that faces toward the slider 20, a depression 38 formed in the other leg 33 and formed in an interior side 39 thereof that faces toward the guide rail, and a recess 40 formed in the other or outer side 41 thereof and facing away from the slider 20 and communicating with the depression 38 thereof, and a latch device 42 having one or more (such as two) catches 43 extended from the other leg 33 and extended into the recess 40 thereof. It is preferable that the end caps 30, 31 include an identical structure or configuration, but disposed opposite to each other (FIGS. 1, 2), and the catches 43 are provided for attaching or securing or retaining the guide beams 50 to the end caps 30, 31.

The retaining devices 60 each include one or more protrusions 61 extended from one end portion 62 thereof for engaging into the corresponding cavities 36 of the legs 34 of the end caps 30, 31 and for securing to the end caps 30, 31 with such as force-fitted engagements, and a flap 63 extended or bent from the other end portion 64 thereof for engaging into the recess 40 of the other leg 33 of the corresponding end caps 30, 31 and for anchoring or positioning the retaining devices 60 to the end caps 30, 31, and an orifice 65 formed in the flap 63 for engaging with the catches 43 of the latch device 42 of the end caps 30, 31 and thus for detachably securing or retaining the retaining devices 60 and thus the guide beams 50 to the end caps 30, 31 respectively without additional fasteners or tools. The other end portion 64 of the retaining device 60 may be engaged with or into the depression 38 of the other leg 33 of the end caps 30, 31 and for anchoring the retaining devices 60 to the end caps 30, 31.

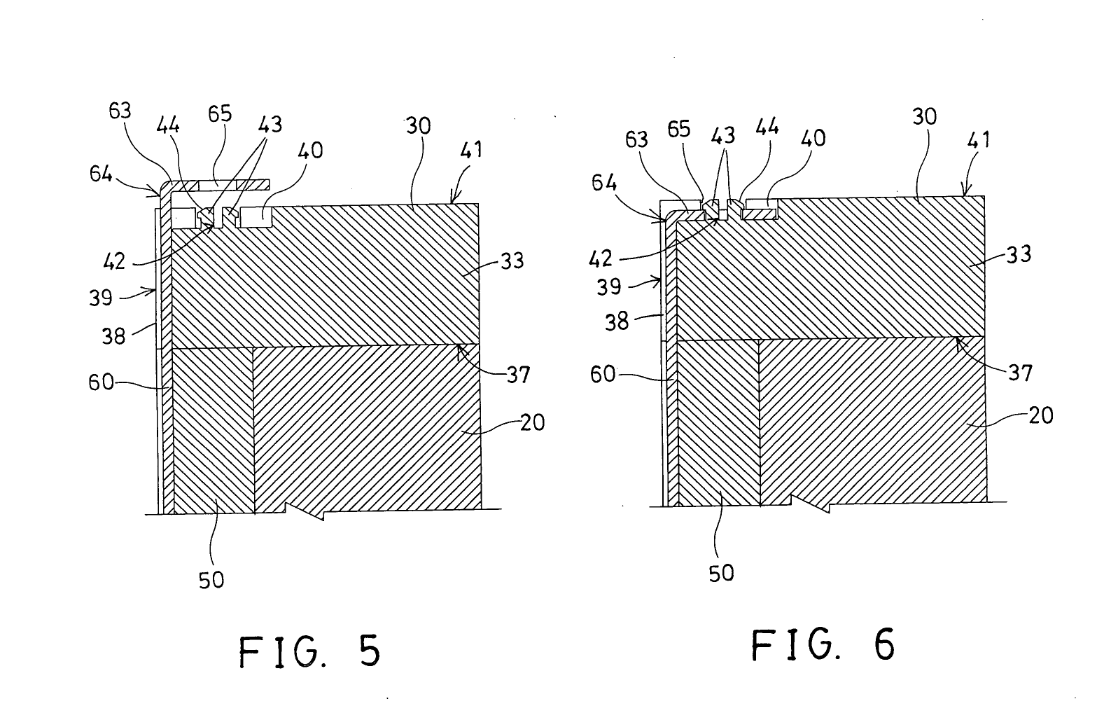

It is preferable that the catches 43 of the latch device 42 each include a tilted or inclined surface 44 formed in the free end portion thereof (FIGS. 5, 6) for engaging with the flap 63 of the retaining devices 60 and for allowing the catches 43 of the latch device 42 to be easily engaged into the orifices 65 of the flaps 63 of the retaining devices 60. The catches 43 of the latch device 42 may not be easily disengaged from the orifices 65 of the flaps 63 of the retaining devices 60 unless the catches 43 of the latch device 42 are forced or bent or disengaged from the orifices 65 of the flaps 63 of the retaining devices 60 by such as the users.

Accordingly, the linear motion guide apparatus in accordance with the present invention includes a retaining device solidly attachable to the slider and the end cap for solidly retaining the ball bearing device to the slider and the end cap and for preventing the retaining device and the ball bearing device from being disengaged from the slider and the end cap.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A linear motion guide apparatus comprising:
a slider,
a first end cap and a second end cap attached to side portions of said slider,
at least one guide beam attached to said slider and engaged between said first and said second end caps for engaging with a ball bearing device and for retaining said ball bearing device to said slider, and
at least one retaining device attached to said first and said second end caps and engaged with said at least one guide beam for retaining said at least one guide beam to said slider and said first and said second end caps,
said at least one guide beam including at least one projection extended therefrom for engaging with said at least one retaining device and for slidably retaining said at least one retaining device to said at least one guide beam.

2. The linear motion guide apparatus as claimed in claim 1, wherein said at least one guide beam includes a groove formed therein for slidably receiving said at least one retaining device.

3. The linear motion guide apparatus as claimed in claim 2, wherein said groove of said at least one guide beam is formed by two ribs, and said ribs each include at least one opening formed therein.

4. The linear motion guide apparatus as claimed in claim 1, wherein said at least one retaining device includes a first end portion engaged with said first end cap and a second end portion engaged with said second end cap.

5. The linear motion guide apparatus as claimed in claim 4, wherein said second end cap includes at least one cavity formed therein, and said at least one retaining device includes at least one protrusion extended from said second end portion thereof for engaging into said at least one cavity of said second end cap and for securing said at least one retaining device to said second end cap.

6. The linear motion guide apparatus as claimed in claim 4, wherein said first end cap includes a latch device extended therefrom for engaging with said first end portion of said at least one retaining device and for securing said at least one retaining device to said first end cap.

7. The linear motion guide apparatus as claimed in claim 6, wherein said first end cap includes a recess formed therein for receiving said first end portion of said at least one retaining device and for anchoring said first end portion of said at least one retaining device to said first end cap.

8. The linear motion guide apparatus as claimed in claim 7, wherein said at least one retaining device includes a flap bent from said first end portion thereof for engaging into said recess of said first end cap.

9. The linear motion guide apparatus as claimed in claim 8, wherein said at least one retaining device includes an orifice formed in said flap for engaging with said latch device.

10. The linear motion guide apparatus as claimed in claim 4, wherein said first end cap includes a depression formed therein for receiving said first end portion of said at least one retaining device.

11. A linear motion guide apparatus comprising:
a slider,
a first end cap and a second end cap attached to side portions of said slider,
at least one guide beam attached to said slider and engaged between said first and said second end caps for engaging with a ball bearing device and for retaining said ball bearing device to said slider, and
at least one retaining device attached to said first and said second end caps and engaged with said at least one guide beam for retaining said at least one guide beam to said slider and said first and said second end caps,
said at least one retaining device including a first end portion engaged with said first end cap and a second end portion engaged with said second end cap, and said first end cap including a latch device extended therefrom for engaging with said first end portion of said at least one retaining device and for securing said at least one retaining device to said first end cap.

12. The linear motion guide apparatus as claimed in claim 11, wherein said first end cap includes a recess formed therein for receiving said first end portion of said at least one retaining device and for anchoring said first end portion of said at least one retaining device to said first end cap.

13. The linear motion guide apparatus as claimed in claim 12, wherein said at least one retaining device includes a flap bent from said first end portion thereof for engaging into said recess of said first end cap.

14. The linear motion guide apparatus as claimed in claim 13, wherein said at least one retaining device includes an orifice formed in said flap for engaging with said latch device.

15. The linear motion guide apparatus as claimed in claim 11, wherein said first end cap includes a depression formed therein for receiving said first end portion of said at least one retaining device.

16. The linear motion guide apparatus as claimed in claim 11, wherein said second end cap includes at least one cavity formed therein, and said at least one retaining device includes at least one protrusion extended from said second end portion thereof for engaging into said at least one cavity of said second end cap and for securing said at least one retaining device to said second end cap.

17. The linear motion guide apparatus as claimed in claim 11, wherein said at least one guide beam includes a groove formed therein for slidably receiving said at least one retaining device.

18. The linear motion guide apparatus as claimed in claim 17, wherein said groove of said at least one guide beam is formed by two ribs, and said ribs each include at least one opening formed therein.

19. The linear motion guide apparatus as claimed in claim 17, wherein said at least one guide beam includes at least one projection extended therefrom and extended into said groove thereof for engaging with said at least one retaining device and for slidably retaining said at least one retaining device to said at least one guide beam.
